(19) United States
(12) Patent Application Publication
(10) Pub. No.: US 2020/0308900 A1
(43) Pub. Date: Oct. 1, 2020

(54) DOOR LOCKING SYSTEM

(71) Applicant: Youngjae CHOI, Gwangju (KR)

(72) Inventor: Youngjae CHOI, Gwangju (KR)

(21) Appl. No.: 16/663,346

(22) Filed: Oct. 25, 2019

(30) Foreign Application Priority Data
Apr. 1, 2019 (KR) 10-2019-0037646

(51) Int. Cl. E06B 3/58; E06B 7/18; E06B 3/02; E06B 3/28; E06B 3/60

(52) U.S. Cl. CPC E06B 3/5871; E06B 7/18; E06B 3/605; E06B 3/28; E06B 3/02

(57) ABSTRACT

Provided is a door locking system including: a frame (10) including a hole (11) and a stopper hole (12), wherein the hole (11) is formed inside the frame (10), wherein a door glass (60) is fitted in the hole (11, wherein the stopper hole (12) is recessed from the hole (11) into a first sidewall of the frame (10); a captive bolt (20) inserted into the first sidewall of the frame (10) in a first direction toward the stopper hole (12); and a stopper (30) fitted in the stopper hole (12), wherein the second direction is perpendicular to the first direction.

### CROSS-REFERENCE TO RELATED APPLICATION

This application claims priority under 35 U.S.C. § 119 to Korean Patent Application No. 10-2019-0037646 filed on Apr. 1, 2019, the disclosure of which is hereby incorporated by reference in its entirety.

### FIELD OF INVENTION

Embodiments of the present invention relate to a technology about tempered glass doors installed in the entrances of houses or buildings, and more particularly, to a door locking system for fixing a glass to a frame tightly and strongly by providing a stopper to the frame and putting a captive bolt to the frame, and setting a tempered glass into a hole of the frame and tightening the captive bolt for the stopper to be pressed against the tempered glass such that the tempered glass can contact the frame closely and can be fixed to the frame tightly and safely, thereby to improve the durability of the tempered glass and the frame further and make their assembling and disassembling easier and enhance the construction and work ability.

### BACKGROUND OF INVENTION

Generally, doors are installed in buildings for entry of people, and there are many types for such doors, for example, classified as sliding doors, hinged doors, rotary doors, and so on. Particularly, there are installed inward/outward opening and closing, that is, hinged-typed doors in public buildings, department stores, hotels, big buildings, etc. in which lots of people are coming and using and therefore, tempered glasses are mostly set for such doors.

Regarding the tempered glass door, its exterior appearance is pretty, and even with the door closed, views outside the door can be well seen through glasses and persons entering buildings can be also well checked. Further, a safety cover is installed in order to prevent accidents during entry process, such as hands or clothes of passing persons caught therein, or carrying bags or conveyed objects being also caught there into.

Conventional tempered glass door was generally made with a tempered glass and a frame in which the tempered glass was put and fixed into upper and lower frames horizontally aligned and displaced, and then, the frames with the tempered glass are installed in the frames of the door entrance ends or rotatably to the door frames for opening/closing type.

As representative conventional technology for fixing the glass door, there has been disposed Korean Patent Registration No. 10-0452229 (Fixing Apparatus for Glass Door).

In the conventional technology as above, a glass is installed fixedly to a glass door directly without use of frames so as to provide visual satisfaction for beauty and even for long time usage, opening/closing state desired by a user can be stably maintained, and its maintenance and correction was easy and simple.

Further, as representative conventional art technology of safety door for increasing indoor energy efficiency, there has been disposed Korean Patent Registration No. 10-1144650 (Tempered Glass Safety Door with Improved Insulating Ability).

The conventional technology as above is characterized in that the horizontal door frame and the vertical door frame to form the frames of the tempered glass safety door show the heat insulation capability in itself, and thus, provides the effect of increasing indoor heat save performance and also energy save efficiency.

However, the conventional technology has defects of poor durability because its tempered glass is not fixed firmly to its upper and lower frames, and furthermore, its installation work in the location is very difficult to meet the inclined slope of the door frame in relation to the bottom surface of the entrance in the installation location, and the construction work ability is decreased because its assembling and disassembling was complicated.

### PRIOR ART DOCUMENTS

Korean Patent No. 10-0452229
Korean Patent No. 10-1144650
Korean Patent No. 10-1460600
Korean Patent No. 10-1669409
Korean Utility No. 20-0472535

### SUMMARY OF INVENTION

In an embodiment, a door locking system is provided including: a frame (10) including a hole (11) and a stopper hole (12), wherein the hole (11) is formed inside the frame (10), wherein a door glass (60) is fitted in the hole (11, wherein the stopper hole (12) is recessed from the hole (11) into a first sidewall of the frame (10); a captive bolt (20) inserted into the first sidewall of the frame (10) in a first direction toward the stopper hole (12); and a stopper (30) fitted in the stopper hole (12), wherein the second direction is perpendicular to the first direction.

The door locking system may further include: a coupling hole (13) formed through the first sidewall of the frame (10) in the first direction, wherein a screw thread is formed on an inner wall of the coupling hole (13); and a long hole (14) formed inside the first sidewall of the frame (10) and extending along a longitudinal direction, wherein the longitudinal direction is perpendicular to the first direction.

The door locking system may further include: a coupling part (17) extending from the first sidewall of the frame (10) to between the long hole (14) and the stopper hole (12); and a cut part (16) formed through an upper portion of the frame (10) and communicating with the long hole (14), wherein the coupling part (17) extends up to the cut part (16).

The stopper (30) is in a thin-rod shape. A pressure groove (31) is formed on the stopper (30) to receive the captive bolt (20).

Embodiments of the present invention provide a door locking system for tempered glasses in order to solve the problems in the conventional door fixing system for tempered glass in that the durability becomes decreased because the tempered glass cannot be fixed firmly to its frame, and the construction work ability becomes decreased because the assembling and disassembling in the door glass fixing are complicated, and thus, provides a door glass fixing system which is mainly composed of a frame, a captive bolt, and a stopper, and is processed by setting a stopper in the frame of the door while putting a captive bolt into the frame, and inserting one sheet of tempered glass into the hole of the frame, and then, tightening the captive bolt for the stopper to keep pressing the tempered glass which comes to contact closely and tightly with and be firmly fixed to the frame.

Further, the present invention is directed to provide a glass fixing system to door for increasing the durability by fixing tempered glass to the frame through a stopper tightly and strongly and increasing the construction work ability by making its assembling and disassembling simple and easy and also, for making the glass fixing process more simplified at the entrance of installation location by checking the bottom surface of the entrance and the slope of the door frame.

In accordance with an aspect of the present invention, the door locking system may include frames displaced to be aligned with each other at the upper and lower portions of a door glass, the frame having a hole into which the door glass is inserted and fixed, and a stopper hole formed at one side of the hole; a captive bolt to be engaged with one side of the frame; and a stopper inserted and provided inside the stopper hole of the frame.

Further, in the embodiment of the present invention, the frame may include a coupling hole with screw threads like nut grooves through its side portion where the stopper hole is formed; and long holes formed along the longitudinal direction, at its upper both portions, and at its middle and lower portions.

Further, in the embodiment of the present invention, the stopper is formed as bar-shaped thin rod in thickness, and a pressure groove can be formed on the middle at side.

Therefore, the present invention provides effects of fixing tempered glass to a frame strongly to improve their durability and making simplified their assembling and disassembling process to increase the construction work ability, since the stopper is provided in the frame, and the captive bolt is inserted into the frame, and tempered glass is placed to be put into the hole of the frame while the captive bolt comes into and tightens further so that the stopper applies pressure on the tempered glass and can be closely and tightly contacted there with.

Further, the present invention provides effects of fixing tempered glass to the frame through the stopper firmly, increasing the construction work ability by their simplified assembling and disassembling process, and making easier the installation work at the door entrance corresponding to the bottom surface of the entrance and the slope of the door frame.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The foregoing and other features and advantages of the present inventions will be apparent from the more particular description of preferred embodiments of the present inventions, as illustrated in the accompanying drawings in which like reference characters refer to the same parts throughout the different views. The drawings are not necessarily to scale, emphasis instead being placed upon illustrating the principles of the present inventions.

FIG. 1 is a perspective view showing the embodiment of the present invention.

FIG. 2 is a side sectional view showing the main portion of the embodiment of the present invention.

FIG. 3 is a side sectional view showing the frame of the present invention.

FIG. 4 is a side sectional view showing the assembling process of the present invention.

FIG. 5 is a side sectional view showing the installation process of door glass according to one embodiment of the present invention.

FIG. 6 is a side sectional view showing the installation state of door glass according to one embodiment of the present invention.

FIG. 7 is a side sectional view showing the setting process of the cover in the present invention.

FIG. 8 is a main side sectional view showing the captive bolt and the stopper according to one embodiment of the present invention.

### DETAILED DESCRIPTION OF THE EMBODIMENTS

Since exemplary embodiments of the present invention are provided only for structural and functional descriptions of the present invention, the present invention should not be construed as limited to the embodiments set forth herein. Thus, it will be clearly understood by those skilled in the art that the exemplary embodiments of the present invention may be embodied in different forms and include equivalents that can realize the spirit of the present invention. It should be understood, however, that it is not intended to limit the present invention to the particular forms disclosed, but on the contrary, the present invention is to cover all modifications, equivalents, and alternatives falling within the spirit and scope of the present invention as defined by the appended claims.

It will be understood that when an element or part is referred to as being “connected to” or “coupled to” another element or part, it can be directly connected or coupled to the other element or part or intervening elements or parts may be present. In contrast, when an element is referred to as being “directly connected to” or “directly coupled to” another element or part, there are no intervening elements or parts present. Meanwhile, spatially relative terms, such as “between” and “directly between” or “adjacent to” and “directly adjacent to” and the like, which are used herein for ease of description to describe one element or feature's relationship to another element(s) or feature(s) as illustrated in the figures, should be interpreted similarly.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless expressly defined in a specific order herein, respective steps described in the present invention may be performed otherwise. That is, the respective steps may be performed in a specified order, substantially at the same time, or in reverse order.

The present invention will now be described more fully hereinafter with reference to the accompanying drawings, in which exemplary embodiments of the present invention are shown.

In view of the main components of the embodiment of the present invention referring to the drawings, the door locking system may include frames (10) to be respectively displaced at the upper and lower portions of a door glass (60) with faced in opposite to each other, each frame (10) having a hole (11) which the door glass (60) is fitted into and fixed in, and a stopper hole (12) positioned at one side of the hole (11); a captive bolt to be engaged into one side of the frame (10); a stopper (30) fitted and installed on the stopper hole (12) of the frame (10) and a cover (40) fitted and engaged on the outer side of the frame (10).

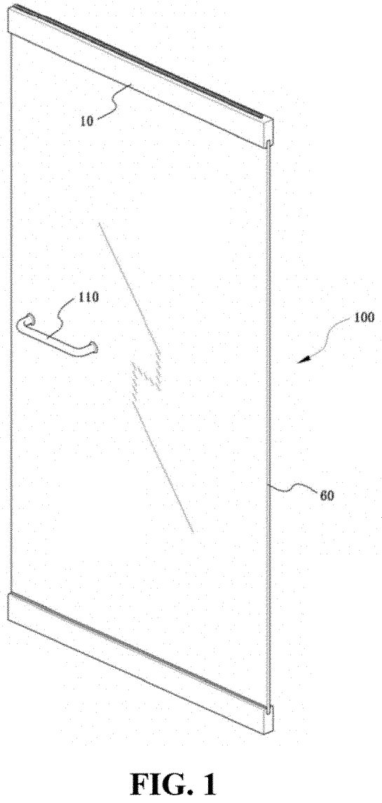

In the main component elements of the embodiment, the frame (10) is one of the main elements to form a door (100) together with the door glass (60) which is fitted in both upper and lower frames (10). As shown in FIGS. 1 to 3, the frame (10) has a rectangular shape (or is entirely overall on the whole shaped as rectangle.) and manufactured by extrusion molding with aluminum or stainless steel.

A tempered glass door (100) is generally formed such that the frames (10) are horizontally displaced up and down to face each other, the door glass (60) is inserted between the up and down frames (60) and fixed, and a door handle (110) to be held by persons coming in and out is positioned in the middle of the door glass (60). Further, a mohair (70) is provided in the frame (60) to enhance soundproof and wind shield.

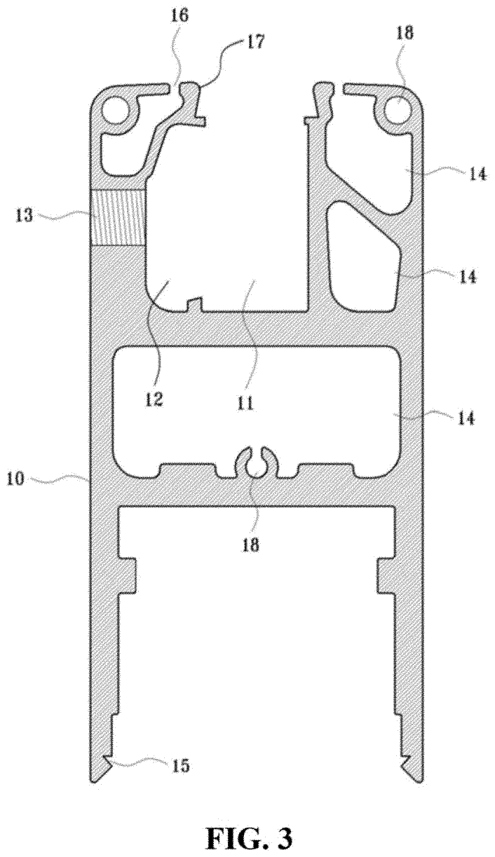

The frame (10) is prepared by cutting in appropriate length after extrusion molding, and as shown in FIG. 3, the hole (11) for receiving the door glass (60) by fitting is formed in the middle of the upper side of the frame (10), and the stopper hole (12) is formed inside the hole (11) at its one side. A coupling hole (13) is penetratingly formed on the side of the frame (10) where the stopper hole (12) is located, as nut grooves having threads formed thereon.

About the coupling hole (13), a plurality of, for example, three to five coupling holes (13) may be formed with constant interval on the frame (10), that is, along its longitudinal direction, and the captive bolts (20) to be explained in more can be inserted and coupled therein respectively.

Further in the frame (10), long holes (14) are formed in its upper both sides, in the middle, and in its lower side respectively. Particularly, the long hole (14) which is located in the lower side is formed with its bottom opened, and has hook grooves (15) inside the both portions of the hole (14) in the opened lower side respectively.

Further in the frame (10), coupling parts (17) in round shape are formed on the both upper sides of the hole (11) respectively, and a cutting part (16) is formed in adjacent to each coupling part (17). The cut part (16) is formed by cutting the close portion of the coupling part (17) to be through with the long hole (14) located on the upper side so that the both coupling parts (17) can be moved appropriately.

Further in the frame (10), a plurality of coupling holes (18) are formed on its both upper sides, and the coupling holes (18) are used to couple the both upper sides of the frame (10) with an end pad (not shown) by bolts.

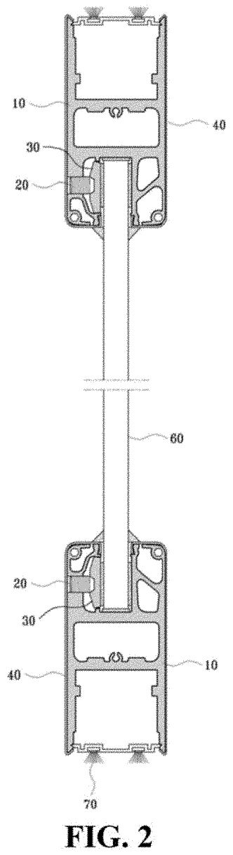

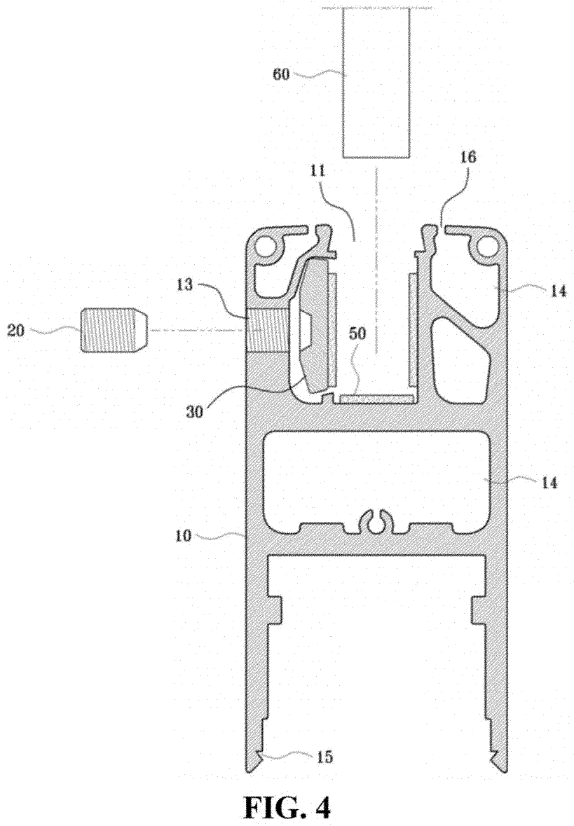

Further, among main components of the embodiment of the present invention, the captive bolt (20) functions to fix the door glass (60) to the frame (10), and as shown in FIGS. 2 and 4, is formed as the shape of headless bolt, and there are a plurality of coupling holes (13) formed on the side of the frame (10), wherein the captive bolt (20) is inserted into each coupling hole (13) and coupled therewith.

Further, among main components of the embodiment of the present invention, the stopper (30) functions to apply pressure on the door glass (60) and fix it to the frame (10). As shown in FIGS. 2 and 4, the stopper (30) is provided with inserted into the stopper hole (12) of the frame (10) in the longitudinal direction, and is formed of thin rod shape in thickness, wherein a pressure groove (31) is formed in its middle side portion.

The stopper (30) is formed by pressure molding with aluminum or synthetic resin (plastic), and then, is cut with appropriate length, and is inserted into the stopper hole (12) and is disposed in the position of the coupling hole (13).

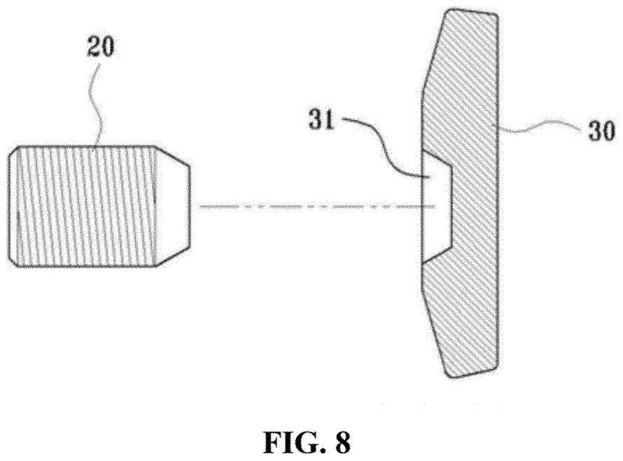

As shown in FIG. 8, the pressure groove (31) is the portion closely contacted with the end of the captive bolt (20), is formed as round-shaped groove. The captive bolt (20) pushes the stopper (30) so as to apply pressure on the door glass (60) and to be closely contacted there with.

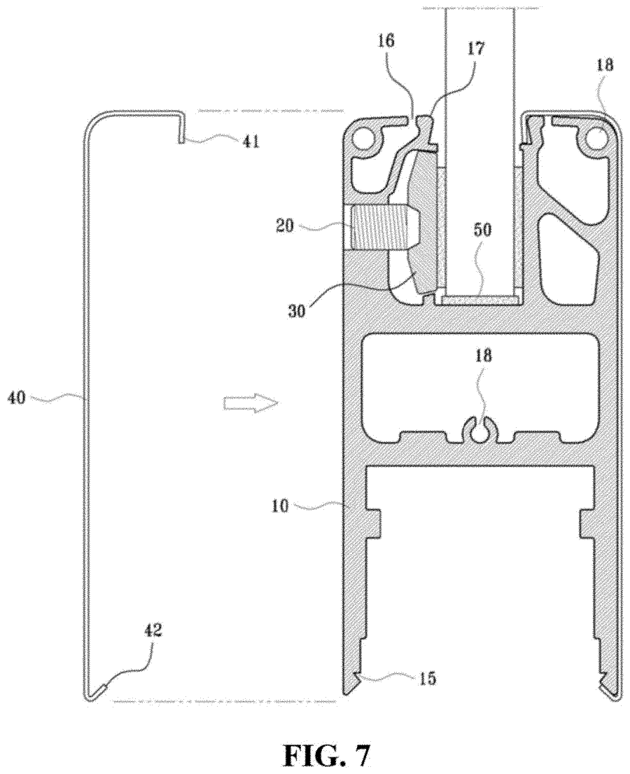

Further, in the main components of the embodiment of the present invention, the cover (40) functions to beautifully cover the exterior side portion of the frame (10), and as shown in FIGS. 2 and 7, the cover (40) is formed by cutting thin stainless steel panel, wherein on its upper portion, a latch (41) is formed by making the shape after bending in the longitudinal direction and on its lower portion, a hook (42) is formed by making the shape after bending in the longitudinal direction.

The cover (40) can be coupled with the frame (10) so that its upper latch (41) is fitted into the coupling part (17) of the frame (10) and its lower hook (42) is fitted into the hook groove (15) of the frame (10).

Since the coupling part (17) of the frame (10) has appropriate flexibility by the cut part (16), the latch (41) of the cover (40) can be caught by the coupling part (17) easily so that assembling and disassembling of the cover (40) can be also conducted easily.

Therefore, in the embodiment of the present invention structured as above, as shown in FIG. 4, the door glass (60) is fitted into the hole (11) of the frame (10) and settled thereon, and the stopper (30) is fitted into the stopper hole (12) and assembled there with. The captive bolts (20) are coupled into the coupling holes (13) of the frame (10) respectively, and packings (50) are placed and mounted on the bottom and the inner side portion of the hole (11), and on the side portion of the stopper (30) respectively.

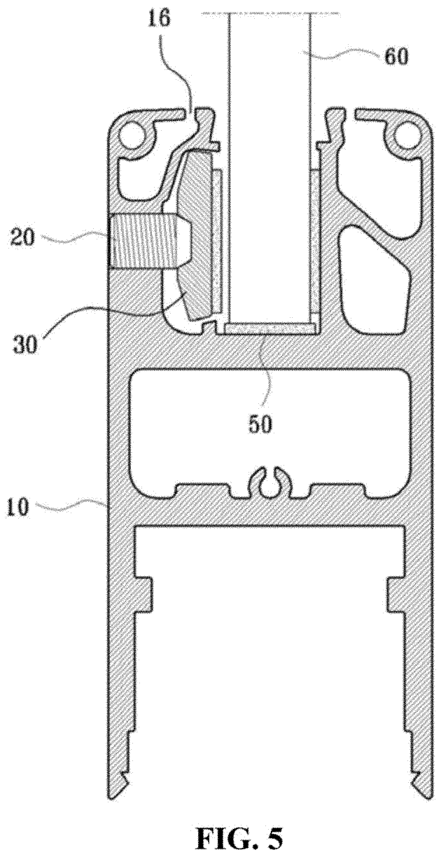

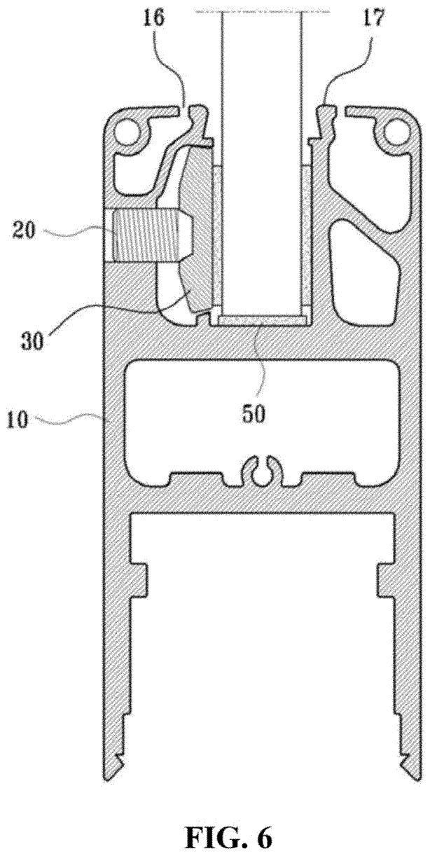

Then, in view of the fixing state of the door glass (60) as shown in FIGS. 5 and 6, if the captive bolt (20) being put and inserted into the frame (10) comes to be tightened, the end of the captive bolt (20) comes to closely contact with the pressure groove (31), and the stopper (30) is then pressed inward and applies pressure on the door glass (60) through the packing (50) so that the door glass (60) can be strongly fixed and settled inside the hole (11).

Therefore, according to the embodiment of the present invention, the door glass can be firmly fixed and safely installed by tightening the captive bolt so as to increase the durability, and the construction work for glass door installation can be further simplified corresponding to the bottom surface of the entrance and the inclined slope of the door frame as well as easy and simple assembling and disassembling processes.

Furthermore, according to the embodiment of the present invention, the number of components is reduced owing to the simple structures of the frame, the captive bolt, and the stopper, and the manufacturing expenses for them is reduced, and the door glass can be firmly and safely fixed to the frame.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures.

### DESCRIPTION OF NUMERALS

| | | | |
|---|---|---|---|
| 10: | frame | 11: | hole |
| 12: | stopper hole | 13: | coupling hole |
| 14: | long hole | 15: | hook grooves |
| 16: | cut part | 17: | coupling part |
| 20: | captive bolt | 30: | stopper |
| 31: | pressure groove | 40: | cover |
| 41: | latch | 42: | hook |
| 50: | packing | 60: | door glass |
| 70: | mohair | 100: | door |

What is claimed is:

1. A door locking system comprising:
a frame (10) including a hole (11) and a stopper hole (12), wherein the hole (11) is formed inside the frame (10), wherein a door glass (60) is fitted in the hole (11, wherein the stopper hole (12) is recessed from the hole (11) into a first sidewall of the frame (10);
a captive bolt (20) inserted into the first sidewall of the frame (10) in a first direction toward the stopper hole (12); and
a stopper (30) fitted in the stopper hole (12),
wherein the second direction is perpendicular to the first direction.

2. The door locking system as claimed in claim 1, further comprising:
a coupling hole (13) formed through the first sidewall of the frame (10) in the first direction, wherein a screw thread is formed on an inner wall of the coupling hole (13); and
a long hole (14) formed inside the first sidewall of the frame (10) and extending along a longitudinal direction, wherein the longitudinal direction is perpendicular to the first direction.

3. The door locking system as claimed in claim 2, further comprising:
a coupling part (17) extending from the first sidewall of the frame (10) to between the long hole (14) and the stopper hole (12); and
a cut part (16) formed through an upper portion of the frame (10) and communicating with the long hole (14),
wherein the coupling part (17) extends up to the cut part (16).

4. The door locking system as claimed in claim 1,
wherein the stopper (30) is in a thin-rod shape,
wherein a pressure groove (31) is formed on the stopper (30) to receive the captive bolt (20).
